(19) United States
(12) Patent Application Publication
(10) Pub. No.: US 2015/0222112 A1
(43) Pub. Date: Aug. 6, 2015

(54) WIRELESS-COMMUNICATION ENABLED SURGE PROTECTOR FOR DISTRIBUTED SYSTEMS

(71) Applicant: Toshiba Lighting & Technology Corporation, Kanagawa (JP)

(72) Inventors: Eric J. Wallace, Houston, TX (US); Keisuke Ono, Houston, TX (US)

(21) Appl. No.: 14/171,072

(22) Filed: Feb. 3, 2014

(51) Int. Cl. H02H 3/22; H02H 3/20; H02H 3/04

(52) U.S. Cl. CPC H02H 3/22; H02H 3/042; H02H 3/207

(57) ABSTRACT

An example system for monitoring power in a distributed network may include a first surge protector at a first physical location and a second surge protector at a second physical location. The first surge protector may be coupled to a first power source, a first electrical device that receives power from the first surge protector, and a first wireless transmitter. The second surge protector may be coupled to a second power source, a second electrical device that receives power from the second surge protector, and a second wireless transmitter. A receiver at a physical location remote from the first and second physical locations may receive wireless output signals from the first and second surge protectors that indicates conditions of the corresponding surge protector.

### FIELD

Embodiments described herein relate generally to powering distributed electrical devices, and specifically to a wireless-communication enabled surge protectors for distributed systems.

### BACKGROUND

An electrical device may include sensitive electrical components that can be damaged by power surges. A surge protector may be positioned between a power source and the electrical device to absorb and dissipate power surges before they reach the electrical device and damage the sensitive components. The components of the surge protectors that absorb or dissipate the power surges may have limited lifespans. And when the components wear out, the sensitive electrical components of the electrical device may be exposed to power surges. Distributed systems may include many electrical devices and different physical locations, and each power source may have a separate power source.

### BRIEF DESCRIPTION OF THE DRAWINGS

Some specific exemplary embodiments of the disclosure may be understood by referring, in part, to the following description and the accompanying drawings.

FIG. 1 is a diagram illustrating an example network comprising distributed nodes and a control unit or receiver, according to aspects of the present disclosure.

FIG. 2 is a diagram of an example node, according to aspects of the present disclosure.

FIG. 3 is a diagram of an example surge protector, according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Embodiments described herein relate generally to lighting fixtures and control thereof, and specifically to a wirelessly-controlled smart light emitting diode (“LED”) luminaire.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. It may also include one or more interface units capable of transmitting one or more signals to a controller, actuator, or like device.

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

Illustrative embodiments of the present disclosure are described in detail herein. In the interest of clarity, not all features of an actual implementation may be described in this specification. It will of course be appreciated that in the development of any such actual embodiment, numerous implementation specific decisions are made to achieve the specific implementation goals, which will vary from one implementation to another. Moreover, it will be appreciated that such a development effort might be complex and time-consuming, but would nevertheless be a routine undertaking for those of ordinary skill in the art having the benefit of the present disclosure.

The terms “couple” or “couples” as used herein are intended to mean either an indirect or a direct connection. Thus, if a first device couples to a second device, that connection may be through a direct connection or through an indirect mechanical or electrical connection via other devices and connections. Similarly, the term “communicatively coupled” as used herein is intended to mean either a direct or an indirect communication connection. Such connection may be a wired or wireless connection such as, for example, Ethernet, local area network (LAN), radio frequency, power-line communication (PLC), or other communication means that would be appreciated by one of ordinary skill in the art in view of this disclosure. Thus, if a first device communicatively couples to a second device, that connection may be through a direct connection, or through an indirect communication connection via other devices and connections.

Hereinafter, embodiments will be described with reference to the drawings. Each drawing is a schematic view for describing an embodiment of the present disclosure and promoting the understanding thereof. The drawings should not be seen as limiting the scope of the disclosure. In each drawing, although there are parts differing in shape, dimension, ratio, and so on from those of an actual apparatus, these parts may be suitably changed in design taking the following descriptions and well-known techniques into account.

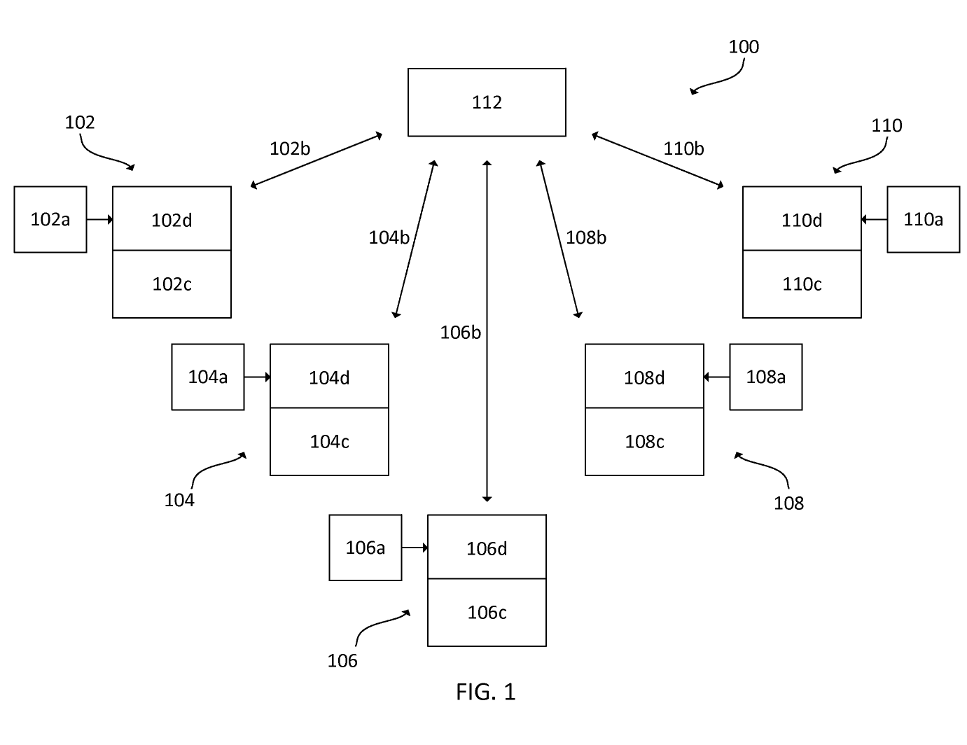

FIG. 1 is a diagram illustrating an example network 100 comprising distributed nodes 102-110 and a control unit or receiver 112, according to aspects of the present disclosure. The nodes 102-110 may be distributed in different physical locations, either on a small or a large scale. For example, the nodes 102-110 may comprise nodes located within a single building, a large facility, a city, etc. Each of the nodes 102-110 may receive power from a corresponding power source 102a-110a. Some or all of the power sources 102a-110a may be common, such as the public power grid in a city or a local power system in a house or building. The control unit or receiver 112 may comprise an information handling system that is communicably coupled with the nodes 102-110 through one or more respective wireless communication channels 102b-110b, which may comprise, for example, RF signals between transmitters and/or receivers (not shown) coupled to each one of the nodes 102-112 and the control unit or receiver 112. The wireless communication channels 102b-110b may be established through a series of pings, for example, to determine whether both transmitter and receiver are operational and transmitting/receiving over acceptable frequency ranges.

In certain embodiments, each of the nodes 102-110 may comprise respective electrical devices 102c-110c that draw power from the corresponding power sources 102a-110a. Example electrical devices may include electronic devices that are primarily used in a distributed arrangement, such as street lights, security cameras, wireless hotspots, etc. Each of the nodes 102-110 may comprise electrical devices of the same type, or the nodes 102-110 may comprise electrical device of mixed-types. Additionally, although only one electrical device is shown at each node 102-110, a node may comprise multiple electrical devices that are physically collocated.

In addition to the electrical devices 102c-110c, each of the nodes 102-110 may comprise respective surge protectors 102d-110d. The surge protectors 102d-110d may be coupled to the respective power sources 102a-110a and provide power from power sources 102a-110a to the electrical devices 102c-110c. The surge protectors 102d-110d may prevent voltage and/or current surges in the respective power sources 102a-110a from reaching and potentially damaging sensitive electric components of the electrical devices 102c-110c. The surge protectors 102d-110d may comprise one or many different types of surge protectors with many different types of configurations, including surge protectors comprising metal oxide varistors, transient voltage suppression diodes, thyristor surge protection devices, etc., or some combination of the listed components. Each of the surge protectors 102d-110d may comprise the same type of surge protector or the surge protectors 102d-110d may be of mixed-type.

According to aspects of the present disclosure, one or more of the surge protectors 102d-110d may communicate with the control unit or receiver 112 over the corresponding wireless communication channels 102b-110b. The surge protectors 102d-110d may communicate to the control unit or receiver 112 one or more conditions of the respective one of the surge protectors 102d-110d. Example conditions include the health of the surge protector, a failure within the surge protector, and a location of the surge protector, such as an absolute location of the surge protector from a global positioning system (GPS) device. The control unit or receiver 112 may receiver, process, and/or display the conditions of the surge protectors 102d-110d, allowing for a user or an automatic process to monitor the surge protectors 102d-110d to determine when a failure has occurred or to schedule maintenance or replacement for a surge protector that will soon fail.

The surge protectors 102d-110d may have limited lifetimes that depend on the number of time the surge protector absorbs or dissipates a voltage and/or current surge. Example surge protectors may comprise clamping voltages, with any received voltage above the clamping voltage comprising a surge that must be dissipated within the circuitry of the surge protector instead of being passed to the device coupled to the surge protector. The electric components of the surge protectors responsible for absorbing the excess voltage and/or current (e.g., metal oxide varistors) may have limited lifetimes that depend on the number of times the components conduct excess current and/or dissipate excess voltage. In certain embodiments, the health of the surge protector may comprise a count of the number of times voltage and/or dissipation has occurred, or a comparison between the number of voltage and/or dissipations and a threshold number of dissipations for the surge protector. For example, certain surge protectors may withstand up to 10,000 to 20,000 amperes all at once or over several surges before losing effectiveness, and the number of high amperage strikes of a certain time duration, such as 20 microseconds, may be counted.

In certain embodiments, one or more of the surge protectors 102d-110d may comprise a control wire through which the health of the surge protector may be determined. In particular, a low voltage direct-current (DC) signal may be received at a surge protector through the control wire, and the voltage level of a corresponding DC output signal of the surge protector may be determined. In certain embodiments, the low voltage DC signal may be generated at the node corresponding to the surge protector using local transformer and rectifier circuitry. Generally, the more voltage or amperage strikes to which the surge protector is subjected, the lower the voltage level of the DC output signal will be. Accordingly, by identifying the voltage level of the DC output signal, the DC voltage drop can be determined, and the number of strikes and overall health of the surge protector may be extrapolated. If the voltage level of the DC output signal is below a certain threshold, for example, the surge protector may be deemed compromised and in need of replacement.

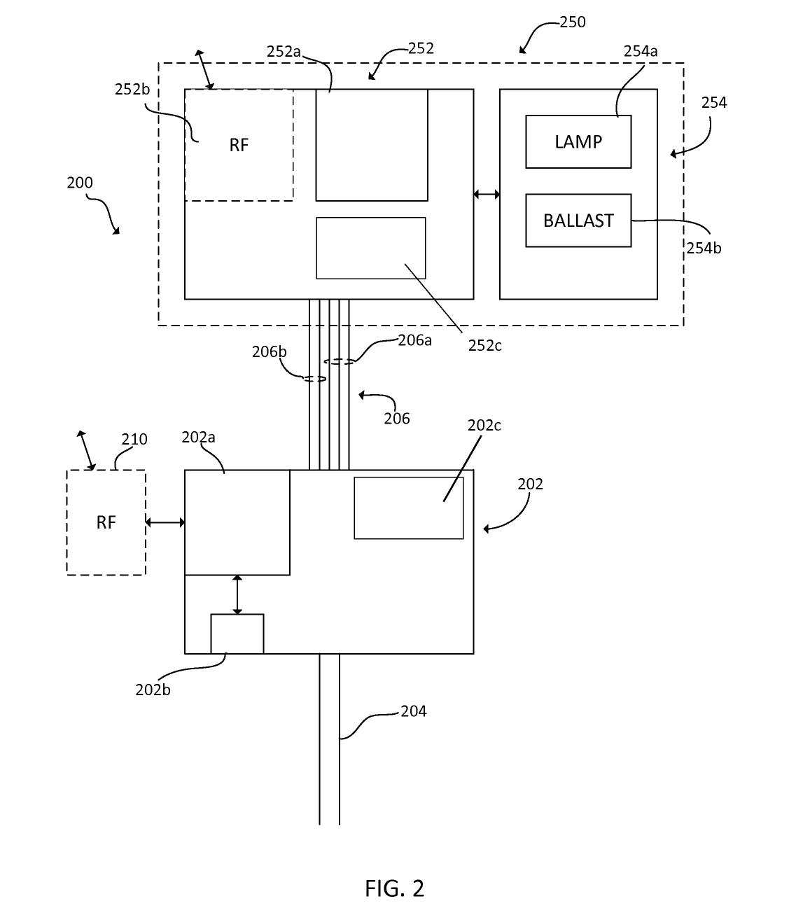

FIG. 2 is a diagram of an example node 200, according to aspects of the present disclosure. In the embodiment shown, the node 200 comprises a surge protector 202 and a electrical device 250. The electrical device 250 comprises a luminaire with a controller 252 coupled to light electronics 254, including lamp 254a and ballast 254b. The luminaire 250 may be one luminaire out of a plurality of luminaires in a system of street lights, with each street light comprising a single luminaire and corresponding to a single node in a distributed network. In other embodiments, the electrical device 250 may comprise a security camera, a wireless hotspot, or other devices positioned in a distributed manner at multiple physical locations.

In the embodiment shown, the surge protector 202 is coupled to a power source (not shown) through a cable 204. The surge protector 202 may also be coupled and transmit power to the luminaire 250 through one or more wires 206. The surge protector 202 may comprise a control unit 202a responsible for monitoring the conditions of the surge protector 202 and controlling communications that identify the conditions of the surge protector 202, described above. For example, the control unit 202a may comprise a processor and a memory device coupled to the processor, with the memory device containing a set of instructions that, when executed by the processor, cause the processor to monitor a condition of a surge protection circuit within the surge protector and communicate that condition to a remote receiver.

In certain embodiments, the control unit 202a may be communicably coupled to a wireless transmitter 210, which may be coupled to the surge protector 202 via a wire 212 or may be integrated into the surge protector 202. The wireless transmitter 210 may comprise, for example, an antenna or radio module that transmits signals in one or more radio frequencies. The control unit 202a may generate one or more output signals via a low-voltage output signal generator within the control unit 202a and send the output signals to the wireless transmitter 210 for transmission, the output signals corresponding to the conditions of the surge protector 202. The wireless transmitter 210 may, in response, convert the output signals and transmit them via radio frequency signals to a remote receiver or control unit, as is described above.

In certain embodiments, the wireless transmitter through which the conditions of the surge protector 202 are transmitted may be located in the electrical device to which the surge protector 202 provides power. In the embodiment shown, the controller 252 of the luminaire 250 may comprise a processor 252a, such as a microcontroller, and a wireless transmitter 252b capable of sending and/or receiving radio frequency signals to/from a remote device. The surge protector 206 may transmit both power and communications signals to the controller 252 through the wires 206. Specifically, a first subset 206a of the wires 206 may comprise a power output from the surge protector 202 (e.g., live, ground, and neutral wires), and a second subset 206b of the wires 206 may comprise a one- or two-wired communications pathway between the surge protector 202 and the controller 252, through which the low-voltage output signal from the control unit 202a is transmitted.

The processor 252a may be responsible for controlling the operation of the luminaire 250, including the wireless transmitter 252b. For example, the processor 252a may control circuitry that receives power from the surge protector over wires 206a and, based on an algorithm or other set of instructions, control when to transmit power to the light electronics 254. Additionally, the processor 252a may be communicably coupled to the wireless transmitter 252b and may control when, how, and what type of information is transmitted from the wireless transmitter 252b. Like the wireless transmitter 210, the wireless transmitter 252b may comprise, for example, an antenna or radio module that transmits signals in one or more radio frequencies.

In operation, the surge protector 202 and in particular the control unit 202a of the surge protector may monitor conditions at the surge protector 202 and transmit output signals to controller 252 over the set of wires 206b. The signals may be transmitted over a single wire in serial form or over two wires in parallel form. Other transmission schemes are possible. In certain embodiments, the processor 252a may receive the output signal from the surge protector 252a and transmit a command to the wireless transmitter 252b to transmit the output signal. In other embodiments, the processor 202a of the surge protector 202 may be able to command the wireless transmitter 252b directly, transmitting output signals without involving the processor 252a.

In certain embodiments, the surge protector 202 or control unit 202a may further comprise a GPS sensor 202b. The GPS sensor 202b may identify the physical location of the surge protector 202. The physical location of the surge protector 202 may be received from the GPS sensor 202b at the control unit 202a, and the location may be included into an output signal containing the conditions of the surge protector 202. By including the physical location, surge protectors with errors or in need of maintenance can be easily identified and tracked by their locations in a large distributed system.

The conditions at the surge protector 202 may include the health of the surge protector, determined using the low-voltage DC signal described above. In certain embodiments, the surge protector 202 may provide an alternating current (AC) power signal to the electrical device 250 and receive the low-voltage DC signal from the electrical device 250. In the embodiment shown, the electrical device 250 comprises transformer and rectifier circuitry 252c in the controller 250. The transformer and rectifier circuitry 252c may receive all or a portion of the AC power signal from the surge protector 202 and generate the low-voltage DC signal, which may be transmitted back to the surge protector 202 through one or more wires 206, and which also may be used as a power source for the processor 252a and other electrical components of the device 250. Circuitry within the surge protector 202, either in the controller 202a or devoted circuitry 202c, may receive the low-voltage DC signal and generate a corresponding DC output signal, which can be used by the controller 202a or transmitted over one or more wires 206 to the processor 252a to determine the health of the surge protector 202. In certain embodiments, transformer and rectifier circuitry may be located at the surge protector 202 such that the surge protector 202 generates the low-voltage DC signal.

As described above, the output signal from the surge protector 202 may be received at a remote receiver or control unit. The remote receiver or control unit may comprise an information handling system with a display device that generates a visualization or other signal corresponding to the received output signal and the surge protector conditions indicated by the output signal. For example, the remote receiver may generate a graphic indicating a percentage degradation of one or more surge protectors in the distributed network.

In certain embodiments, the output signals from all of the surge protectors in a network may be tracked and recorded in a centralized location, such as a database or server. The server may monitor changes in the conditions of the surge protectors and generate specific messages to maintenance personnel regarding to need to replace or repair a particular surge protector. The specific message may comprise audio or visual indicators that identify the specific location of the faulty surge protector.

In other embodiments, the surge protectors of a distributed network may only transmit output signals when an error has occurred, rather the sending constant or periodic update signals. In those embodiments, when an output signal transmission is received from a surge protector, a message to maintenance personnel may be generated immediately. In yet other embodiments, the surge protectors in a network may all transmit periodic status signals that are received and tracked by a centralized receiver. If a surge protector does not transmit the status signal within a designated time period, it may indicate that an error has occurred, which may trigger a message to maintenance personnel regarding a faulty surge protector.

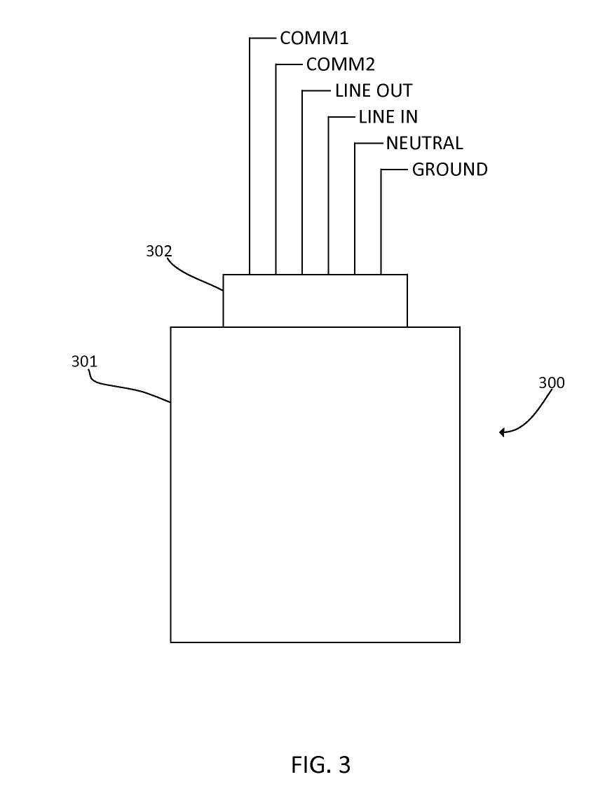

FIG. 3 is a diagram of an example surge protector 300, according to aspects of the present disclosure. Surge protector 300 comprises a rectangular housing 301 that contains the electrical circuitry from the surge protector 300, which may be rated to dissipate surges up to five kilovolts and/or five kiloamperes, although other ratings are possible. The housing 301 may comprise one of many standard sizes for surge protectors that would be appreciated by one of ordinary skill in the art in view of this disclosure, and may be constructed of plastics or another non-conductive material. The surge protector 300 may transmit power and communications signals through a standardized connector 302 with designated wires and corresponding pins on both the surge protector 300 and a electrical device coupled to the surge protector (not shown). In the embodiment shown, the wires comprise Comm1 and Comm2 wires through which low-voltage output signals from the surge protector 300 are transmitted to a electrical device; Line-In, Neutral, and Ground power wires for transmitting power to the electrical device; and an optional Line-Out wire from communications from the electrical device to the surge protector 300, such as to receive/transmit low-voltage DC signals for a health determination. In certain embodiments, the surge protector 300 may be coupled to a separate radio module through the Comm1 and Comm2 wires, or the radio module may be integrated into the surge protector 300 within the standard sized housing 301. Although a rectangular shape is shown for surge protector 300, other shapes and sizes are possible, depending on the application.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are defined herein to mean one or more than one of the element that it introduces.

What is claimed is:

1. A system for monitoring power in a distributed network, comprising:
a first surge protector at a first physical location and coupled to
a first power source,
a first electrical device that receives power from the first surge protector, and
a first wireless transmitter;
a second surge protector at a second physical location and coupled to
a second power source,
a second electrical device that receives power from the second surge protector, and
a second wireless transmitter; and
a receiver at a location remote from the first and second physical locations that is communicably coupled to the first wireless transmitter and the second wireless transmitter and receives an output signal from at least one of the first surge protector and the second surge protector that indicates a condition of the corresponding surge protector.

2. The system of claim 1, wherein at least one of the first electrical device and the second electrical device comprises at least one of a luminaire, a security camera, and a wireless hotspot.

3. The system of claim 1, wherein the first wireless transmitter comprises a radio module that is one of coupled to the surge protector via a wire or integrated into the surge protector.

4. The system of claim 1, further comprising a global positioning sensor coupled to the surge protector.

5. The system of claim 1, wherein the first wireless transmitter comprises a radio module integrated within the first electrical device.

6. The system of claim 5, wherein the surge protector is coupled to the radio module via a one- or two-wired connection.

7. The system of claim 6, wherein the one- or two-wired connection comprises one or two wires of a group of wires through which power is transmitted to the first electrical device.

8. The system of claim 6, wherein
the first electrical device comprises a luminaire with a controller coupled to light electronics;
the surge protector is coupled to the controller via the one- or two-wired connection; and
the radio module is coupled to the controller.

9. The system of claim 1, wherein the condition of the corresponding surge protector comprises at least one of a health of the surge protector, a failure within the surge protector, and a location of the surge protector.

10. A method for monitoring power in a distributed network, comprising:
positioning a first surge protector at a first physical location and coupling the first surge protector to a first power source and a first electrical device that receives power from the first surge protector;
positioning a second surge protector at a second physical location and coupling the first surge protector to a second power source a second electrical device that receives power from the second surge protector;
establishing a first wireless communication channel between the first surge protector and a receiver located remotely from the first and second physical for transmission of a first output signal from the first surge protector; and
establishing a second wireless communication channel between the second surge protector and the receiver for transmission of a second output signal from the second surge protector.

11. The method of claim 10, wherein at least one of the first electrical device and the second electrical device comprises at least one of a luminaire, a security camera, and a wireless hotspot.

12. The method of claim 11, wherein establishing the first wireless communication channel between the first surge protector and the receiver comprises establishing the first wireless communication channel between the receiver and a wireless transmitter that is one of
coupled to the first surge protector via at least one wire;
integrated within the first surge protector; and
integrated within the first electrical device.

13. The method of claim 11, wherein the first output signal indicates a condition of the first surge protector.

14. The method of claim 13, wherein the condition of the first surge protector comprises at least one of a health of the first surge protector, a failure within the first surge protector, and a location of the first surge protector.

15. The method of claim 11, further comprising determining when an error at one of the first surge protector and the second surge protector has occurred based on a change in one of the respective first and second wireless communication channels.

16. The method of claim 15, wherein the change in one of the respective first and second wireless communication channels comprises at least one of
a presence of an output signal in one of the respective first and second wireless communication channels;
an absence of an output signal in one of the respective first and second wireless communication channels; and
a condition indicated in one of the respective first and second wireless communication channels that corresponds to an error condition.

17. The method of claim 16, further comprising generating an error notification if it is determined that the error has occurred at one of the first surge protector and the second surge protector.

18. An assembly for monitoring power in a distributed network, comprising:
a non-conductive housing;
a control unit within the housing;
a surge protection circuit within the housing and coupled to the control unit;
a low-voltage output signal generator coupled to the control unit; and
a wireless transmitter coupled to the low-voltage output signal generator;
wherein the control unit comprises a processor and a set of instruction coupled to the processor, the set of instructions, when executed by the processor, cause the processor to
monitor a condition of the surge protection circuit;
cause the low-voltage output signal generator coupled to generate an output signal corresponding to the condition.

19. The assembly of claim 18, wherein the assembly further comprises a global positioning sensor coupled to the control unit.

20. The assembly of claim 18, wherein the wireless transmitter is one of
located within the housing; or
coupled to the low-voltage output signal generate using a one- or two-wired connection.
